(19) United States
(12) Patent Application Publication
(10) Pub. No.: US 2015/0053576 A1
(43) Pub. Date: Feb. 26, 2015

(54) Measuring Arrangement

(71) Applicant: Endress + Hauser Conducta Gesellschaft für Mess- und Regeltechnik mbH + Co. KG, Gerlingen (DE)

(72) Inventors: Torsten Pechstein, Radebeul (DE); Thomas Wilhelm, Chemnitz (DE); Michael Hanko, Dresden (DE)

(21) Appl. No.: 14/462,689

(22) Filed: Aug. 19, 2014

(30) Foreign Application Priority Data
Aug. 22, 2013 (DE) 10 2013 109 105.9

(51) Int. Cl. G01N 27/30

(52) U.S. Cl. CPC G01N 27/302
USPC 205/787.5; 204/412

(57) ABSTRACT

A measuring arrangement, comprising: at least three half-cells, each of which has a pH-sensitive membrane, and a measuring circuit, which is embodied to register a half-cell potential of each half-cell relative to a shared reference potential. The half-cell potential of each half-cell depends on the pH-value of a measured liquid contacting its pH-sensitive membrane. The sensitivity of a first of the three half-cells corresponds to a change of its half-cell potential relative to a change of the pH-value of the measured liquid causing it; the sensitivity of a second of the three half-cells corresponds to a change of its half-cell potential relative to a change of the pH-value of the measured liquid causing it; the sensitivity of a third of the three half-cells corresponds to a change of its half-cell potential relative to a change of the pH-value of the measured liquid causing it.

The invention relates to a measuring arrangement and to a method for determining a pH-value of a measured liquid.

The measuring of pH-value in liquids plays an important role in environmental analytics, in chemical and biochemical methods in the laboratory and in industrial process measurements technology. The pH-value corresponds to the negative base-10 logarithm of the H⁺, or H₃O⁺-ion activity in a measured liquid. In dilute solutions, activity and concentration are equal.

Frequently, potentiometric sensors are used for measuring pH-value both in the laboratory as well as also in process analytics. These comprise, as a rule, a measuring half-cell and a reference half-cell.

The measuring half-cell includes a pH-sensitive element, which frequently is embodied as a membrane, on which, in contact with the measured liquid, a potential forms, dependent on the pH-value. The measuring half-cell can have, for example, a pH-sensitive membrane, whose side facing away from the measured liquid is in contact with an internal electrolyte comprising a buffer system. The pH-sensitive membrane is frequently embodied as a glass membrane, which, in contact with an aqueous measured liquid, forms a gel layer. In such case, there occurs at the interface between the glass membrane and the aqueous medium a dissociation, in the case of which alkali-ions of the glass membrane are replaced by protons from the measured liquid, so that a large number of hydroxyl groups are formed in the gel layer. Depending on the pH-value of the measured medium, H⁺-ions diffuse out from the gel layer or into the gel layer. In measurement operation of the half-cell, this occurs both on the surface contacting the internal electrolyte as well as also on the oppositely lying surface of the membrane contacting the measured liquid. Since the inner electrolyte has a constant pH-value, there results across the membrane, thus, a potential difference dependent on the pH-value of the measured medium.

The inner electrolyte is contacted by a potential sensing element, which is embodied, for example, as a metal wire, frequently as a chloridized silver wire. A half-cell potential of the measuring half-cell can be tapped on the potential sensing element. The dependence of the change of the half-cell potential of the measuring half-cell measured relative to a stable reference potential independent of the pH-value referenced to the change causing it, i.e. the change of the pH-value of a measured liquid contacting the half-cell, is referred to as the sensitivity of the measuring half-cell. The half-cell potential can be expressed as a function of the pH-value. Such a function representing the half-cell potential as a function of the pH-value is also referred to as the characteristic curve of the half-cell. This characteristic curve can at least sectionally, i.e. over a portion of the pH-scale, be, to a good approximation, a linear function. This linear function is characterized by a zero-point and a slope. The slope is a measure for the sensitivity of the half-cell.

In the case of potentiometric pH-sensors, the reference potential is provided by the reference half-cell. The reference half-cell comprises a reference electrode embodied frequently as an electrode of second type, e.g. as a silver/silver chloride electrode. This provides ideally a reference potential essentially independent of the composition of the measured liquid. A reference electrode embodied as an electrode of second type includes, formed in a housing, a reference half-cell space, which contains an internal electrolyte. The internal electrolyte is in contact with the measured liquid via a liquid junction, which can be embodied, for example, as an opening through the housing wall or as a diaphragm arranged in the housing wall. The inner electrolyte is contacted by a reference element. In the case of a silver/silver chloride electrode, serving as reference element is a chloridized silver wire, and as inner electrolyte a highly concentrated, e.g. 3 molar, potassium chloride solution. The potential of the reference half-cell can be tapped from the reference element. The voltage measurable between the reference element and the potential sensing element of the measuring half-cell, also referred to as the pH-voltage, can be registered by a measuring circuit and, based on a linear sensor characteristic curve ascertained by calibration, converted into a pH-value.

Although such sensors comprising potentiometric measuring chains assure very precise and reliable measurement results and are well established both in the laboratory as well as also in process analytics, they have a number of disadvantages. Thus, the measuring half-cells comprising a pH-sensitive membrane exhibit, with time, aging phenomena. Also, in the case of the reference electrode, a number of defects or degradation phenomena of the electrodes of second type serving as reference electrode can occur, which degrade the quality of the measuring. Thus, the potential of such reference electrodes tends, in practice, to drift, i.e. to exhibit a slow, however, continued, change of the reference potential.

Another problem associated with the application of electrodes of second type as reference electrode is the escape or drying out of the reference electrolyte, as well as the plugging of the liquid junction by solids, especially difficultly soluble salts. Moreover, there can occur at the diaphragm diffusion potentials and streaming potentials, which degrade the accuracy of measurement. Also, electrode poisons can reach the reference electrode through the liquid junction and cause lasting damage to the sensor. For all these reasons, most of the problems arising in the case of pH-measuring with conventional potentiometric sensors stem from the reference electrode.

The mentioned aging phenomena lead to a change of sensor characteristic variables, especially of zero-point and slope of the sensor characteristic curve describing the dependence of the pH-voltage on the measured variable. These are compensated frequently with regular calibrating of the sensor. In such case, the sensor is supplied with one or more calibration media, which have a known value of the measured variable, e.g. the analyte concentration. For example, for calibration, a pH-sensor is supplied with one or more buffer solutions, each having a known pH-value. The display value of the sensor is adjusted by adapting the sensor characteristic curve furnished in a memory of a sensor electronics to the derivative of measured values from the measurement signal of the sensor, especially by adapting its zero-point and/or slope, to the known value of the measured variable. This procedure is referred to as an adjustment. Since in process measurements technology, however, this procedure is, as a rule, referenced with the not quite fitting concept “calibration”, this label will also be used here and maintained in the following. The regular calibration of sensors leads to the fact that the sensors are necessarily during certain times, when they are being calibrated, not usable. In process measurements technology, where under circumstances a large number of pH-measuring points are operated simultaneously, the regular calibrating of sensors additionally involves a significant logistical effort.

There has existed therefore already for a long time the need for alternative, more robust sensors, which preferably operate without one of the conventional electrodes of second type.

Described in U.S. Pat. No. 4,650,562 is a potentiometric pH-measuring arrangement, which includes a first, conventional pH-sensitive glass electrode serving as measuring half-cell and a second pH-sensitive glass electrode serving as reference half-cell. The sensitivity of the second electrode is reduced by a thermal treatment. The voltage registrable between the measuring and reference half-cells serves as the pH-dependent, measurement signal.

Such measuring arrangements have, however, not been accepted. Thus, H. Galster states in his textbook “pH-Messung, Grundlagen, Methoden, Anwendungen, Geräte (pH-Measurement, Principles, Methods, Applications, Devices”, Chapter 3.3.3, Publisher: VCH Verlagsgesellschaft, Weinheim, Germany 1990, that glass electrodes, which exhibit no complete slope or no slope at all, could, theoretically, be used as reference electrodes in pH-measuring chains, but he advises against such, since the glass membranes with decreased sensitivity will exhibit cross sensitivities to other substances and, consequently, the galvanic voltage of such reference electrodes is dependent on the composition of the measured solution. Also, a low stability of the reference potential is noted.

Described in European patent application EP 613 001 A1 is a special construction of a potentiometric pH-sensor, which has two measuring chains, which have, respectively, a pH-sensitive glass electrode and a shared reference electrode. The glass electrodes have different inner buffers, so that the two measuring chains possess different chain zero points. The determining of the sensitivity of the measuring chains represented by the slope of the sensor characteristic curve and the ascertaining of the measured value occur simultaneously in the case of this construction, while the sensor is extending into the measured liquid for registering the measured value. It is claimed that the zero-point error is small compared with the slope error, so that with the assistance of the construction described in EP 613 001 A1 a recalibration of the sensor can be omitted.

It is evident, however, that the greatest portion of the error in the case of measuring chains with a reference electrode comprising a liquid junction results from changes of the reference electrode, which makes itself noticeable in the change in the chain zero point. Even in the case of greatly aged pH-glass electrodes, the changes of the sensitivity of the measuring chain are, in contrast, comparatively small.

It is, consequently, an object of the invention to provide a measuring arrangement, which is suitable for overcoming the above related disadvantages of the state of the art.

This object is achieved by a measuring arrangement as defined in claim 1. Subject matter the invention includes, moreover, a method for determining a pH measured value in a measured medium, as such method is defined in claim 22.

The measuring arrangement of the invention includes:

at least three half-cells, each of which has a pH-sensitive membrane,
a measuring circuit, which is embodied to register a half-cell potential of each half-cell relative to a shared reference potential,
wherein the half-cell potential of each half-cell depends on the pH-value of a measured liquid contacting its sensitive membrane,
in such a manner that each half-cell has a respective sensitivity,
wherein the sensitivity of a first of the three half-cells corresponds to a change of its half-cell potential relative to a change of the pH-value of the measured liquid causing it;
wherein the sensitivity of a second of the three half-cells corresponds to a change of its half-cell potential relative to a change of the pH-value of the measured liquid causing it;
wherein the sensitivity of a third of the three half-cells corresponds to a change of its half-cell potential relative to a change of the pH-value of the measured liquid causing it; and
wherein the sensitivity of the first half-cell differs from the sensitivity of the second half-cell.

In such case, the half-cell potential of the first half-cell has a first zero-point as a function of the pH-value of the measured liquid,

the half-cell potential of the second half-cell has a second zero-point as a function of the pH-value of the measured liquid, and
the half-cell potential of the third half-cell has a third zero-point as a function of the pH-value of the measured liquid,
wherein the first zero-point differs from the third zero-point.

Since the sensitivity of the first half-cell differs from the sensitivity of the second half-cell, for measuring a pH-value, a pH-sensitive half-cell with a first sensitivity can be referenced to a pH-sensitive half-cell with a different, second sensitivity, e.g. lessened relative to the first sensitivity. A referencing to a reference electrode with a pH-independent reference potential is, consequently, no longer required. Thus, a conventional reference half-cell with a liquid junction does not have to be used.

Since the first zero-point differs from the third zero-point, there is enabled, besides the referencing of the first half-cell to the second half-cell, also a self-compensation of the measuring arrangement as regards changes of the sensitivity of the first half-cell occurring over the course of the operating time of the measuring arrangement, in that the slope of the first, respectively the third, half-cell can be ascertained simultaneously with the measured value determination.

In an advantageous embodiment, the sensitivity of the first half-cell equals the sensitivity of the third half-cell. The terminology, equal sensitivity, means here an agreement within the usual manufacturing tolerances, which amounts according to the current state of the art to, for instance, ±2 mV/pH. Based on the fact that the sensitivity of the first and second half-cells can be described, at least over a portion of the pH-scale, by means of a linear function with the same slope, a change of the slope associated with the first, respectively the third, half-cell occurring over the course of time can be determined, and, in given cases, to a degree, compensated, when the first and third half-cells have an essentially identical aging behavior under identical measuring conditions. Especially, a slope associated with the first half-cell can be referenced to a slope associated with the third half-cell. This enables a stable and reliable measured value determination over a long period of time.

The sensitivity of the first half-cell can be reduced especially relative to the sensitivity of the second half-cell. pH-sensitive glass membranes with decreased slope are less prevalent and tend in given cases to age faster than the well known, established half-cells with pH-glass membranes, whose sensitivity can be described to a good approximation by means of a linear function, whose slope lies near the theoretical value of 59 mV/pH, such as e.g. McInnes glass. An intrinsic referencing is, consequently, advantageous, especially as regards a half-cell with decreased sensitivity.

The second zero-point can either be equal to the first or third zero-point, or differ from these.

The measuring arrangement can in an embodiment include at least a fourth half-cell having a pH-sensitive membrane. The half-cell potential of this fourth half-cell depends on the pH-value of the measured liquid contacting the sensitive membrane, wherein the measuring circuit is embodied to register the half-cell potential of the fourth half-cell relative to the shared reference potential, and wherein the fourth half-cell has a sensitivity, which corresponds to a change of its half-cell potential relative to a change of the pH-value of the measured liquid causing it, wherein the sensitivity of the fourth half-cell equals the sensitivity of the second half-cell.

In a further development of this embodiment, the half-cell potential can as a function of the pH-value of the measured liquid have a fourth zero-point, which differs from the second zero-point. This embodiment permits also detection, and, in given cases, compensation, of changes of the sensitivity of the second, respectively the fourth, half-cell occurring over the course of time.

A further lessening of the measurement uncertainty is possible, when the measuring arrangement has more than four half-cells, especially five, six or eight half-cells, each with a pH-sensitive membrane, wherein the corresponding sensitivities of the half-cells beyond the first, second, third and fourth half-cell can be the same as or differ from the sensitivity of the first or second half-cell. In the last case, it is advantageous when the sensitivities of the additional half-cells are pairwise the same.

The first and third zero-points as well as the second and fourth zero-points or, in case the measuring arrangement has other, additional half-cells, other zero-points, can pairwise be the same. It is in an additional embodiment also an option that all measuring half-cells of the measuring arrangement have different zero-points.

Advantageously, the first slope and the third slope differ from one another in such a manner that the accuracy of measurement of the measuring arrangement is better than 0.1 pH. This is assured in an advantageous embodiment when the slope of a first linear function representing the dependence of the half-cell potential of the first half-cell on the pH-value of the measured liquid differs from the slope of a second linear function representing the dependence of the half-cell potential of the second half-cell on the pH-value of the measured liquid by at least 6 mV/pH, especially by at least 10 mV/pH, preferably by at least 20 mV/pH.

The first and second zero-points differ from one another in an advantageous embodiment in such a manner that the accuracy of measurement of the measuring arrangement is better than 0.1 pH. Especially, the first and second zero-points can differ from one another by at least 0.5 pH, especially by at least 1 pH, preferably by at least 2 pH.

The half-cells of the measuring arrangement can each have an internal electrolyte in contact with the pH-sensitive membrane and a potential sensing element contacting the internal electrolyte and electrically conductively in contact with the measuring circuit for registering the half-cell potential. The half-cells can be accommodated in a shared housing, for example. In this embodiment, there is formed in this housing for each half-cell a chamber, in which its inner electrolyte is accommodated and which is sealed on one end by the pH-sensitive membrane of the half-cell, wherein there extends into the internal electrolyte a potential sensing element, which is connected electrically conductively with the measuring circuit.

The inner electrolyte of the half-cells can comprise a pH-buffer system, wherein each glass membrane of the measuring arrangement is essentially chemically inert relative to the internal electrolyte in contact with it. The composition of the inner electrolyte is preferably so selected that under the operating conditions, which the glass electrode is expected to encounter or will encounter according to specification, there occur between the glass membrane and the internal electrolyte essentially no chemical reactions, which could lead to a degradation of the glass membrane or change of the zero point that would degrade the measured value formation.

In order to achieve a third zero-point different from the first zero-point, the inner electrolyte of the first half-cell can have a pH-value different from the pH-value of the internal electrolyte of the third half-cell. The inner electrolyte of the second half-cell can correspondingly have a pH-value different from the pH-value of the internal electrolyte of the, in given cases, present, fourth half-cell. The first and second half-cells can have inner electrolytes of equal composition. Correspondingly, also the third and fourth half-cells can have inner electrolytes of equal composition. It is in an alternative embodiment also possible that the pH-value of the internal electrolyte of each half-cell differs from the pH-value of the internal electrolyte of the respectively other half-cells.

A potential developing on the pH-sensitive membrane of each half-cell in contact with a measured liquid as a function of the pH-value of the measured liquid is the pH-dependent part of the half-cell potential. The different sensitivities of the first and second half-cells can be assured by giving the pH-sensitive membrane of the first half-cell a composition different from that of the pH-sensitive membrane of the second half-cell. The same holds for the third and fourth half-cells in the case of the above mentioned embodiment having at least four half-cells. The pH-sensitive membranes of the first and third half-cells can have identical compositions, whereby is assured that the first and third half-cells have the same sensitivity. Correspondingly, the membranes of the second and fourth half-cells can have identical compositions.

The different sensitivities of the first, respectively third, half-cells relative to the second half-cell and, in given cases, fourth half-cell can also be assured by providing the second, respectively the fourth, half-cell with a conventional pH-sensitive glass membrane having a slope of the half-cell characteristic curve lying in the region of the theoretical sensitivity of 59 mV/pH, e.g. a McInnes glass or the like, while the pH-sensitive glass membrane of the first, respectively third, half-cell is formed by a conventional pH-sensitive glass membrane having, for example, the same composition as the pH-sensitive glass membrane of the second and, in given cases, fourth half-cell given a thermal treatment and/or a treatment with a substance changing at least the composition of a surface of the membrane in such a manner that its sensitivity is reduced following the treatment.

The measuring arrangement can comprise, conductively connected with the measuring circuit, a reference electrode, which provides the shared reference potential. The measuring arrangement is, in such case, so embodied that the pH-sensitive membranes of its half-cells and the reference electrode are simultaneously contactable with the measured liquid.

The reference electrode can be a conventional reference electrode having a liquid junction, e.g. a silver/silver chloride electrode. In this case, the reference electrode has, filled with a reference electrolyte, e.g. a highly concentrated, especially 3 molar, potassium chloride solution, a housing, into which a reference element, e.g. a chloridized silver wire extends, wherein in the housing wall a liquid junction is arranged, via which the reference electrolyte is in contact with a medium surrounding the reference electrode.

In a preferred embodiment, the reference electrode is an electrode formed of an electrically conductive, especially electron conductive, material, for example, a metal electrode, an electrode formed of a semiconductor material or a carbon electrode, for example, in the form of a graphite or glass carbon electrode. The reference electrode can be embodied as a pin formed of the electrically conductive material, for example, a metal or carbon pin, as a housing wall of the measuring arrangement formed of the electrically conductive material or a coating formed of the electrically conductive material, especially a metal coating, on a housing wall of the measuring arrangement. Preferably, the material of the reference electrode is so selected that it is inert relative to the measured liquid, so that its potential is representative of the redox potential of the measured liquid. The measuring arrangement is so embodied that the pH-sensitive membranes of the half-cells and the reference electrode are contactable simultaneously with a measured medium, especially a measured liquid.

The measuring circuit can be a component of a measuring and evaluation system of the measuring arrangement. The measuring and evaluation system can comprise, connected or connectable with the measuring circuit, an evaluating circuit, which is embodied especially as an electronic circuit, preferably as an electronic data processing system. The measuring and evaluation system can be embodied, based on the potential differences between the respective half-cell potentials and the shared reference potential registered by the measuring circuit, to ascertain the pH-value of the measured liquid in contact with the pH-sensitive membranes of the half-cells.

The measuring and evaluation system can be embodied to ascertain a pH measured value based on the half-cell potential of the first or second half-cell registered relative to the shared reference potential and based on the half-cell potential of the third or, in given cases, the fourth half-cell registered relative to the shared reference potential.

The measuring and evaluation system can supplementally or alternatively be embodied, based on the potential difference between the half-cell potential of the first half-cell and the reference potential, the potential difference between the half-cell potential of the third half-cell and the reference potential and based on the first and third zero-points, to ascertain a first slope representing a sensitivity of the first and third half-cells. Equally, in the case of the above described embodiment with four half-cells, the measuring and evaluation system can be embodied, based on the potential difference between the half-cell potential of the second half-cell and the reference potential, the potential difference between the half-cell potential of the fourth half-cell and the reference potential and based on the second and fourth zero-points, to ascertain a second slope representing a sensitivity of the second and fourth half-cells.

Optionally, the measuring and evaluation system can be embodied, to evaluate a time development of the ascertained slope, or the ascertained slopes, in order to ascertain a state of the measuring arrangement, especially a state of at least one of the half-cells. Based on the time development of the slope, increasing aging of the associated half-cell can be followed. One or more limit values can be predetermined, wherein the measuring and evaluation system can output a warning- or alarm signal, when the slope associated with a half-cell falls below the limit value. For example, a first limit value can be so fixed that, in the case of a subceeding of the limit value, a calibration of the measuring arrangement is required. Alternatively or supplementally, a second limit value can be so fixed that in the case of a subceeding of the limit value, a replacement of the associated half-cell is required.

If the measuring arrangement is embodied in such a manner that the shared reference potential is provided by an essentially inert reference electrode, e.g. a metal electrode or a carbon electrode, extending into the same measured liquid as the pH-sensitive membranes of the half-cells, then the measuring and evaluation system can be embodied, based on the registered potential differences between the half-cell potentials and the shared reference potential as well as an ascertained pH measured value, to determine the redox potential of the measured liquid.

In this embodiment, the measuring arrangement can supplementally comprise at least one other half-cell, whose half-cell potential depends on a concentration of an analyte, especially an analyte different from H⁺, respectively H₃O⁺, wherein the measuring and evaluation system is embodied based on a potential difference between the half-cell potential of the additional half-cell and the potential of the shared reference electrode or another half-cell of the measuring arrangement, to determine the concentration of the analyte. Since, based on the ascertained pH measured value, an absolute value of the shared reference potential is ascertainable, the analyte concentration to be registered with such an additional half-cell can be ascertained by referencing the potential of the additional half-cell relative to the reference potential or alternatively relative to every other half-cell of the measuring arrangement.

In an advantageous embodiment, at least one of the half-cells of the apparatus has a visible marking for identification of the half-cell.

In an additional advantageous embodiment, the measuring arrangement has a housing, for example, a cylindrical housing, in which the half-cells are arranged in such a manner that their pH-sensitive membranes extend out from a base surface of the cylinder, so that they are contactable with the measured liquid by immersion of the base of the housing into the measured liquid. The half-cells can be affixed in the housing in such a manner that they are removable from the housing without damage and are therefore exchangeable. Thus, half-cells, whose maximum duration of operation has expired, can be replaced without problem with a new half-cell of equal construction. Serving as shared reference electrode in this embodiment can be the housing wall, or a coating arranged on the housing wall.

The invention relates also to a method for determining a pH-value of a measured liquid, comprising steps as follows:
contacting at least a pH-sensitive membrane of a first half-cell, a pH-sensitive membrane of a second half-cell and a pH-sensitive membrane of a third half-cell with the measured liquid;
contacting with the measured liquid at least one reference electrode providing a shared reference potential;
registering a potential difference respectively between a half-cell potential of the first half-cell and the reference potential, between a half-cell potential of the second half-cell and the reference potential and between a half-cell potential of the third half-cell and the reference potential, and,
based on the registered potential differences, determining the pH-value of the measured liquid.

The method can be performed especially by means of the above described measuring arrangement. The determining of the pH-value based on the registered potential differences can be performed, for example, by the already mentioned measuring and evaluation system or by another data processing system connected with the measuring and evaluation system and/or the measuring circuit.

Used as shared reference potential can be the potential of a shared reference electrode extending into the measured liquid. Serving as reference electrode can be preferably an electrode formed of an electrically conductive, especially electron conductive, material, for example, a metal electrode, an electrode formed of a semiconductor material or a carbon electrode, for example, in the form of a graphite or glass carbon electrode. The reference electrode can be embodied as a pin formed of the electrically conductive material, for example, metal or carbon, as a housing wall of the measuring arrangement formed of the electrically conductive material or a coating, especially a metal coating, located on a housing wall of the measuring arrangement and formed of the electrically conductive material.

In an embodiment of the method, the half-cell potential of each half-cell is a function of the pH-value of the measured liquid, wherein the pH-value of the measured liquid is determined based thereon, characterized in that

there is associated with the first half-cell a first slope, which corresponds to a slope of a first linear function, which represents a dependence of the half-cell potential of the first half-cell on the pH-value of the measured liquid,
there is associated with the second half-cell a second slope different from the first slope and corresponding to a slope of a second linear function, which represents a dependence of the half-cell potential of the second half-cell on the pH-value of the measured liquid, and
there is associated with the third half-cell a third slope different from the second slope, equal to the first slope, and representing a dependence of the half-cell potential of the third half-cell on the pH-value of the measured liquid.

In such case, moreover, there is associated with the first half-cell a first zero-point, which corresponds to a zero-point of the first linear function, there is associated with the second half-cell a second zero-point, which corresponds to a zero-point of the second linear function,

there is associated with the third half-cell a third zero-point, which corresponds to a zero-point of the third linear function. The zero-points associated with the half-cells with the approximation of a linear characteristic curve represent the actual zero-points of the half-cell characteristic curves determined essentially by the pH-value of the inner electrolyte. In an embodiment, the first zero-point differs from the third zero-point. The first zero-point can equal the second zero-point; it can, however, also differ from the second zero-point.

In the case of this method embodiment, thus the characteristic curve representing the dependence of the half-cell potential on the pH-value of the measured liquid is given by a linear approximation function. The approximation function is characterized by its slope, which serves for the pH-value determination as the slope of the half-cell representing the sensitivity of the half-cell, and by its zero-point.

For determining the pH-value in the case of the here described method, a pH-sensitive half-cell having a first slope representing its sensitivity is referenced to a pH-sensitive half-cell having a second slope different from, e.g. less than, the first slope, wherein the second slope correspondingly represents the sensitivity of the second half-cell. In this way, a conventional reference half-cell with liquid junction can be omitted. A pH measured value can instead be ascertained based on a difference between the half-cell potential of the first or the third half-cell measured relative to the shared reference potential and the half-cell potential of the second half-cell registered relative to the shared reference potential.

Because the first zero-point differs from the third zero-point, besides the referencing of the slope associated with the first half-cell to the slope associated with the third half-cell, also a self compensation of the measuring arrangement is enabled by ascertaining the slope of the first and/or third half-cell simultaneously with the measured value determination.

Based on the fact that the sensitivity of the first and second half-cells can be described by means of a linear function with the same slope at least over a portion of the pH-scale, in a method embodiment, a change of the slope of the first, respectively the third, half-cell occurring over the course of time is detected, and, in given cases, compensated under the approximation that the first and third half-cells show essentially the same type aging behavior under identical measuring conditions. Especially, the slope associated with the first half-cell can be referenced to the slope associated with the third half-cell. This enables a measured value determination, which is stable and reliable over a long time span.

The slope associated with the first half-cell can be determined from the ratio of a difference between the potential difference registered between the first half-cell and the reference potential and the potential difference registered between the third half-cell and the reference potential to a difference between the first and third zero-points.

Additionally, at least one pH-sensitive membrane of a fourth half-cell, especially other pH-sensitive membranes of further half-cells, can be supplied with the measured liquid, wherein a potential difference between the half-cell potential of the fourth, especially each additional half-cell, and the shared reference potential enters into the determining of the pH-value.

The invention will now be explained in greater detail based on the example of an embodiment illustrated in the drawing, the figures of which show as follows:

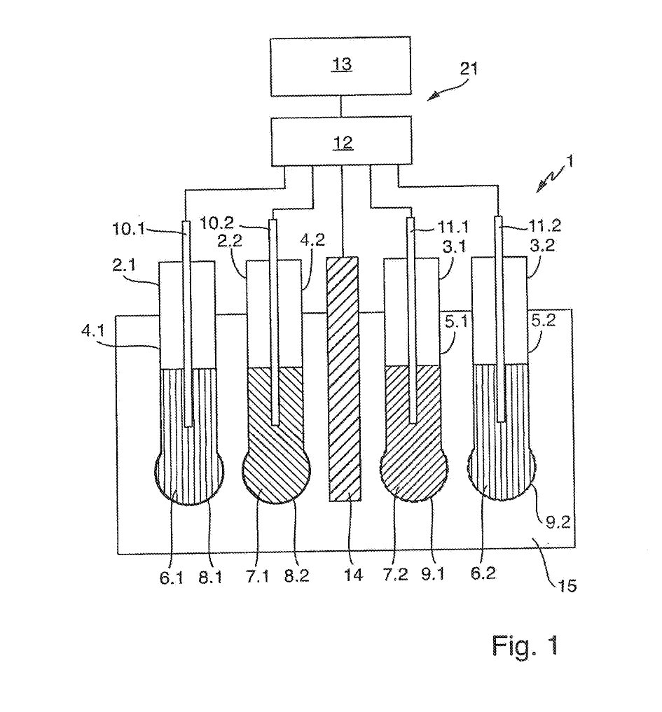

FIG. 1 a schematic representation of a measuring arrangement with four half-cells each having a pH-sensitive membrane;

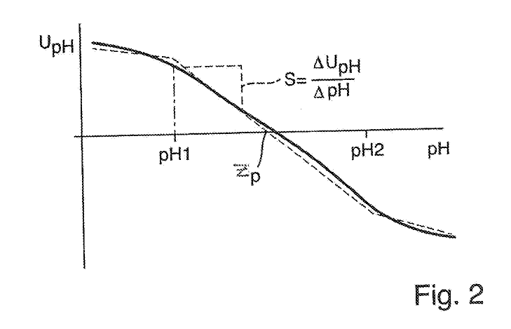

FIG. 2 a schematic representation of the typical curve of a half-cell potential of a half-cell comprising a pH-glass membrane as a function of the pH-value of a measured liquid in contact with the pH-glass membrane;

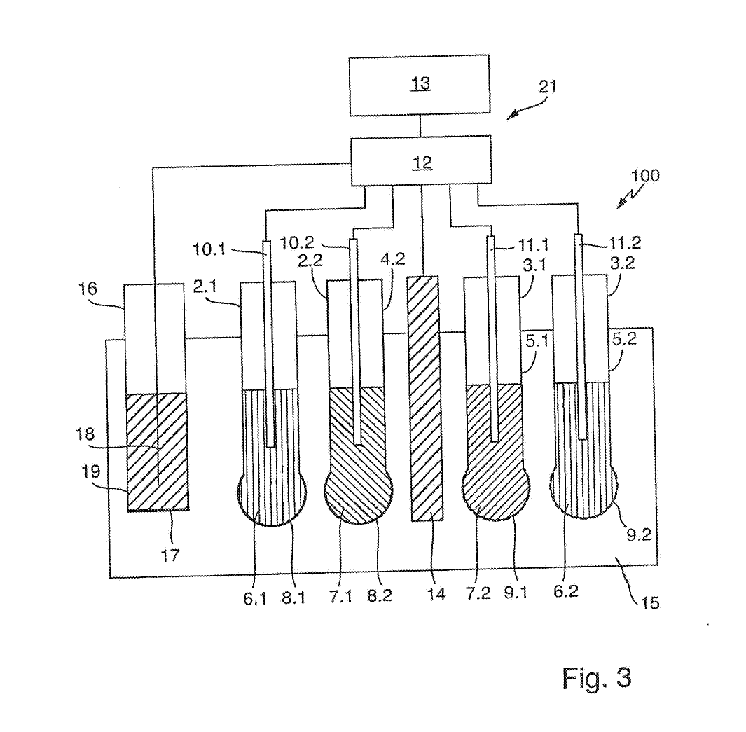

FIG. 3 a schematic representation of a measuring arrangement with four half-cells each having a pH-sensitive membrane and an additional half-cell for potentiometrically measuring an additional parameter;

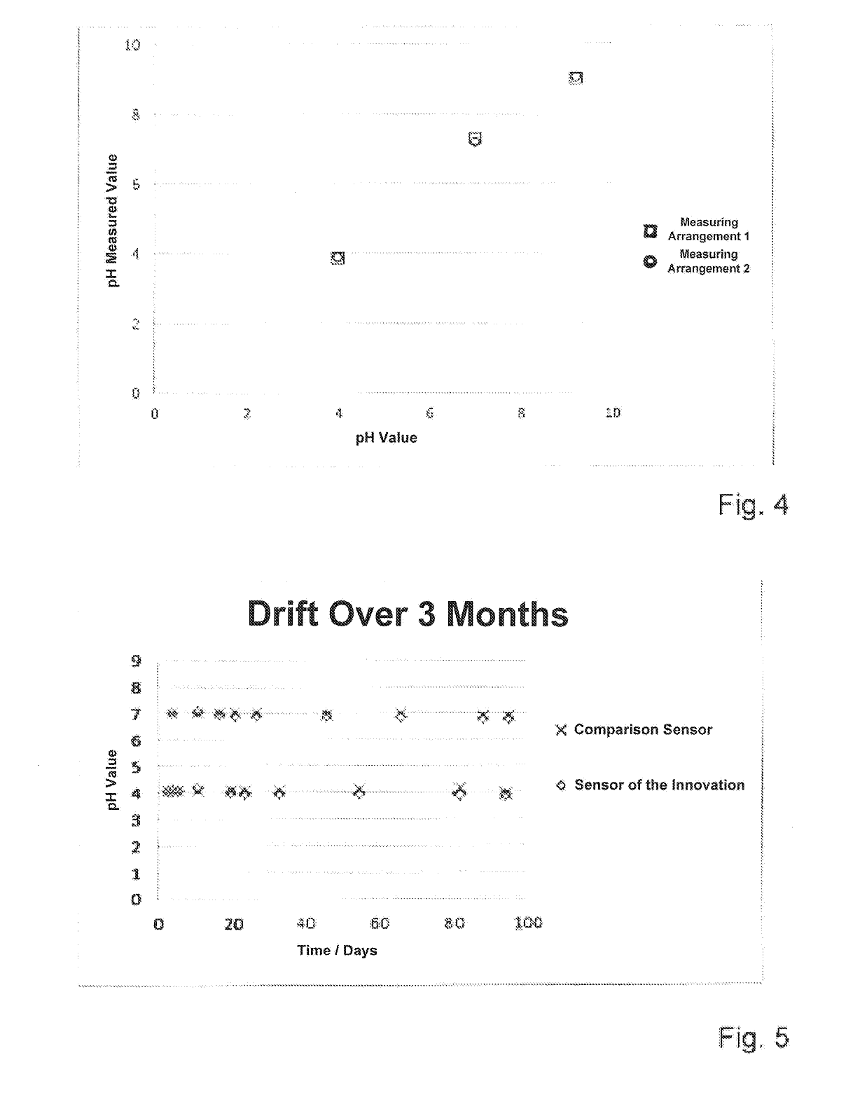

FIG. 4 results of a three-point calibration of measuring arrangements according to FIG. 2;

FIG. 5 a graph of pH measured values registered with a measuring arrangement according to FIG. 2 and with a conventional pH single-rod measuring chain as a function of time over a time span of 3 months.

FIG. 1 shows schematically the construction of a measuring arrangement 1 with four half-cells 2.1, 2.2, 3.1 and 3.2 each having a pH-sensitive membrane. The half-cells 2.1, 2.2, 3.1 and 3.2 are embodied as pH-glass electrodes. Each has a housing 4.1, 4.2, 5.1, 5.2, for example, of glass, in which a chamber is formed containing an internal electrolyte 6.1, 6.2, 7.1, 7.2. The base of the chamber is sealed by a pH-sensitive glass membrane 8.1, 8.2, 9.1, 9.2. Extending into the internal electrolyte 6.1, 6.2, 7.1, 7.2 is, in each case, a potential sensing element 10.1, 10.2, 11.1, 11.2, which is electrically conductively connected with a measuring circuit 12. Serving as potential sensing element can be, for example, an electrical conductor, e.g. a chloridized silver wire or a pin or wire of another metal or carbon. Measuring arrangement 1 includes, moreover, a reference electrode 14, which is likewise electrically conductively connected with the measuring circuit 12. The half-cells 2.1, 2.2, 3.1 and 3.2 and the reference electrode 14 extend into a measured liquid 15, in order to measure its pH-value. The reference electrode can be formed of an electrically conductive material, e.g. of metal or carbon, especially graphite, carbon fiber or glass carbon, which is inert relative to the measured liquid 15.

As already initially described, there forms in contact with the measured liquid on the pH-sensitive glass membranes 8.1, 8.2, 9.1, 9.2, in each case, dependent on the pH-value of the measured liquid 15, a potential, which is registerable by the measuring circuit 12 referenced to the potential of the reference electrode 14.

A typical characteristic curve of a pH-sensitive half-cell embodied as a glass electrode, i.e. the typical curve of the half-cell potential UpH as a function of the pH-value, is qualitatively schematically presented in FIG. 2 (solid line). The terminology, half-cell potential, means the potential registerable at the potential sensing element of the half-cell with reference to a fixed reference potential. A change of the half-cell potential UpH relative to a change of the pH-value evoking it is referred to as the sensitivity of the half-cell. The sensitivity of a pH-glass electrode is essentially influenced by the composition of the pH-sensitive glass membrane. The zero crossing of the characteristic curve corresponds to the pH-value of the internal electrolyte of the half-cell.

In a middle pH-value range, the half-cell characteristic curve extends approximately linearly. At least in this portion between pH1 and pH2, the half-cell potential as a function of the pH-value is, consequently, describable to a very good approximation by means of a linear function (dashed line), which is characterized by a zero-point Zp and a slope s=ΔU_{pH}/ΔpH representing the sensitivity of the half-cell. The approximation can also frequently be acceptable in the edge regions of the pH-scale. The zero-point Zp of this linear function corresponds approximately to the zero crossing of the actual half-cell characteristic curve and corresponds largely to the pH-value of the internal electrolyte of the glass electrode. The slope, as the sensitivity of the half-cell, is essentially determined by the properties of the pH-sensitive glass membrane, especially by its chemical composition. The slope can likewise be influenced by (synthetic) aging of the glass membrane.

The glass membranes 8.1, 8.2 of the first half-cell 2.1 and the second half-cell 2.2 have in the here described example the same chemical composition. Thus, the slope sp1 of a linear function representing the pH-dependence of the half-cell potential of the first half-cell 2.1 equals a slope sp2 of a linear function representing the pH-dependence of the half-cell potential of the second half-cell 2.2.

The glass membranes 9.1, 9.2 of the third half-cell 3.1 and the fourth half-cell 3.2 have in the here described example the same chemical composition, which, however, differs from the chemical composition of the glass membranes 8.1, 8.2 of the first and second half-cells 2.1, 2.2. The chemical composition of the glass membranes 9.1, 9.2 of the third and fourth half-cells 3.1, 3.2 is so selected that a slope sr1 of a linear function representing the pH-dependence of the half-cell potential of the third half-cell 3.1 is reduced relative to the slopes sp1 and sp2 associated with the first and second half-cells 2.1, 2.2. The slope sr1 is equal to a slope sr2 of a linear function representing the pH-dependence of the half-cell potential of the fourth half-cell 3.2.

A linear function describing the dependence of the half-cell potential approximately, at least in a portion of the characteristic curve, for conventionally applied glass electrodes possesses, as a rule, a slope having the theoretical value at room temperature of 59 mV/pH. For example, the first and second half-cells 2.1, 2.2 can be embodied as conventional glass electrodes with an established membrane composition, e.g. of McInnes glass. Known from H. Galster, “pH-Messung, Grundlagen, Methoden, Anwendungen, Geräte (pH-Measurement, Principles, Methods, Applications, Devices)”, Chapter 3.3.3, Publisher: VCH Verlagsgesellschaft, Weinheim, Germany 1990, K. Schwabe, pH-Messtechnik (pH Measurements Technology}, 4th Edition, Publisher: Theodor Steinkopff, Dresden, 1976, as well as from U.S. Pat. No. 4,650,562 and DE 1281183 A1 are glass electrodes with pH-sensitive glass membranes, which have a lessened sensitivity, and method for their manufacture. For example, the third and fourth half-cells 3.1, 3.2 can be implemented with these glass membranes, which provide a reduced slope sr1, sr2.

The inner electrolytes 6.1 and 6.2 of the first half-cell 2.1 and the fourth half-cell 3.2 have in the present example the same pH-value. This can be achieved by using the same chemical composition for the inner electrolytes 6.1 and 6.2. For example, the inner electrolyte 6.1, 6.2 can comprise a pH-buffer system. Since the zero-point Zp (FIG. 2) of the linear function describing the half-cell potential of a pH-glass electrode as a function of the pH-value of the liquid in contact with the glass membrane corresponds at least in a portion of the characteristic curve to the pH-value of the internal electrolyte, correspondingly the zero-point pHp1 associated with the first half-cell 2.1 equals the zero-point pHp2 associated with the fourth half-cell 3.2.

The inner electrolytes 7.1 and 7.2 of the second half-cell 2.2 and the third half-cell 3.1 have in the present example the same pH-value, which, however, differs from the pH-value of the inner electrolytes 6.1 and 6.2 of the first half-cell 2.1 and the fourth half-cell 3.2. This can be achieved by giving the inner electrolytes 7.1 and 7.2 the same chemical composition, which, however, differs from the composition of the internal electrolytes 6.1 and 6.2. Especially, the inner electrolytes 7.1 and 7.2 can comprise a buffer system different from the buffer system of the inner electrolytes 6.1, 6.2. Correspondingly, associated with the second half-cell 2.2 is a zero-point pHr1 of the linear function of the pH-value describing its half-cell potential, in which case zero-point pHr1 equals the zero-point pHr2 correspondingly associated with the third half-cell 3.1. The zero-points pHr1 and pHr2 differ from the zero points pHp1 and pHp2.

In a variation, it is also possible that the internal electrolytes of all four half-cells have pH-values, which differ from one another, so that, correspondingly, four different zero-points result. Suitable buffer systems with the most of varied pH-values are known, for example, from H. Galster, “pH-Messung, Grundlagen, Methoden, Anwendungen, Geräte (pH-Measurement, Principles, Methods, Applications, Devices)”, Publisher: VCH Verlagsgesellschaft, Weinheim, Germany 1990.

Established on the reference electrode 14 is a potential dependent on the composition of the measured liquid. The absolute value of the reference potential delivered by the reference electrode 14 plays, however, no role in the measuring arrangement shown here since, such as detailed further below, the half-cell potentials of all half-cells are measured relative to the shared reference electrode 14 and, in this way, the value of the reference potential does not enter into the measured value determination. The reference electrode can in a variation of the example of an embodiment shown here also be formed as a conventional reference electrode of second type with liquid junction, such as initially described, or by a metal housing wall or as a metal coating on a housing wall of the measuring arrangement.

Measuring arrangement 1 includes a measuring and evaluation system 21, which has a measuring circuit 12 and an evaluation circuit 13 connected with the measuring circuit 12. Measuring circuit 12 is embodied to register and, in given cases, to process further, for example, to amplify and/or to digitize, the potential differences between the sensing elements 10.1, 10.2, 11.1 and 11.2 and the reference electrode 14. The potential differences, in given cases, further processed, are output by the measuring circuit as measurement signals, for example, to the evaluation circuit 13 connected permanently or releasably with it. Evaluation circuit 13 is embodied in the present example as an electronic circuit, especially as a data processing system comprising a microprocessor and memory. It serves for additional processing of the measurement signals, especially for calculating pH measured values from the measurement signals. It can also have a display means, e.g. a display, in order to show measured values or other parameters or diagnosis reports. Equally, the evaluation circuit 13 can have input means or be connectable with input means, via which a user can input queries or parameters. For additional processing of the measurement signals, for example, for calculating measured values and, in given cases, for performing a diagnostic method for ascertaining a state of the measuring arrangement, especially a need for maintenance, the evaluation circuit 13 includes a computer program serving for additional processing of the measurement signals and executable by the microprocessor of the evaluation circuit 13.

In a variation of the example of an embodiment shown here, the half-cells 2.1, 2.2, 3.1 and 3.2 as well as the reference electrode 14 can be combined in a single housing. The housing can, moreover, contain the measuring circuit 12 and, in given cases, the entire measuring and evaluation system 21 or parts of the measuring and evaluation system 21.

The functioning of the measuring arrangement 1 and a method for measuring the pH-value in the measured liquid 15 will now be explained in greater detail. The first half-cell 2.1 and the second half-cell 2.2 are referred to in the following as first and second “pH half-cells”, the third half-cell 3.1 and the fourth half-cell 3.2 are referred to in the following as first and second “reference half-cells”, in order better to illustrate their functions in the measuring arrangement 1. Of course, however, the half-cell potentials of all half-cells 2.1, 2.2, 3.1 and 3.2 depend on the pH-value of the measured liquid 15.

For measuring the pH-value, the glass membranes 8.1, 8.2, 9.1 and 9.2 of all half-cells 2.1, 2.2, 3.1 and 3.2 as well as the reference electrode 14 of the measuring arrangement 1 extend simultaneously into the measured liquid 15. Measuring circuit 12 registers between the potential sensing element 10.1 of the first pH half-cell 2.1 and the reference electrode 14 a first voltage up1, which corresponds to the difference between the half-cell potential u1 of the first pH half-cell 2.1 and the unknown potential x of the reference electrode. Thus, there holds for the half-cell potential u1:

u1=up1+x. (1)

Between the potential sensing element 10.2 of the second pH half-cell 2.2 and the reference electrode 14, the measuring circuit 12 registers a second voltage up2, which corresponds to the difference between the half-cell potential u2 of the second pH half-cell 2.2 and the reference potential x. Holding for the half-cell potential u2 is:

u2=up2+x. (2)

Between the potential sensing element 11.1 of the first reference half-cell 3.1 and the reference electrode 14, the measuring circuit 12 registers a third voltage ur1, which corresponds to the difference between the half-cell potential u3 of the first reference half-cell 3.1 and the reference potential x. Holding for the half-cell potential u3 is:

u3=ur1+x. (3)

Between the potential sensing element 11.2 of the second reference half-cell 3.2 and the reference electrode 14, the measuring circuit 12 registers a fourth voltage ur2, which corresponds to the difference between the half-cell potential u4 of the second reference half-cell 3.2 and the reference potential x. Holding for the half-cell potential u4 is:

u4=ur2+x. (4)

With the mentioned approximation of the pH-dependence of the half-cell potentials of the half-cells 2.1, 2.2, 3.1 and 3.2 by a linear function, there holds for the half-cell potentials u1 to u4, moreover:

u1=sp1(pHp1−pH), (5)

u2=sp2(pHp2−pH), (6)

u3=sr1(pHr1−pH), (7)

u4=sr2(pHr2−pH). (8)

Under the proviso that the slopes sp1, sp2 associated with the pH half-cells 2.1, 2.2 are equal and also in measurement operation under same conditions age due to aging phenomena in equal measure, a current value of the slopes sp1, sp2 associated with the pH half-cells 2.1, 2.2 can be determined, on which the current measured value determination is based:

$$sp 1 = \frac{up 1 - up 2}{pH p 1 - pH p {2}^{′}} \qquad ( 9 )$$

Equally, in corresponding manner, a current value of the slopes sr1, sr2 associated with the reference half-cells 3.1, 3.2 can be determined.

$$sr 1 = \frac{ur 1 - ur 2}{pH r 1 - pH r 2} . \qquad ( 10 )$$

For determining the current pH measured value, a difference of the voltages u1-u3, u1-u4, u2-u3 and u2-u4 can be taken into consideration. This corresponds to a referencing, in each case, of one of the pH half-cells 2.1, 2.2, in each case, to one of the reference half-cells 3.1, 3.2. The unknown potential x of the reference electrode 15 is eliminated by forming the differences. In the following equation (11), arbitrarily the difference between u1 and u3 (equations (1), (3), (5), (7)) is used:

−pHsr1+pHr1sr1−ur1=−pHsp1+pHp1sp1−up1. (11)

By inserting the expressions for the slopes sp1, sr1 set forth in equation (9) and (10) into equation (11) there results as pH-value of the measured liquid 15:

$$pH = \frac{\begin{matrix}pH p 1 ( pH r 2 ( - up 2 + ur 1 ) + pH r 1 ( up 2 - ur 2 ) ) + \\ pH p 2 ( pH r 2 ( up 1 - ur 1 ) + pH r 1 ( - up 1 + ur 2 ) )\end{matrix}}{\begin{matrix}pH r 2 ( up 1 - up 2 ) + pH r 1 ( - up 1 + up 2 ) + \\ ( pH p 1 - pH p 2 ) ( ur 1 - ur 2 )\end{matrix}} . \qquad ( 12 )$$

Evaluation circuit 13 determines based on the above equation the current pH measured value and provides such for display or outputs such to a superordinated unit (not shown in FIG. 1), e.g. a programmable logic process controller.

By simultaneously determining the current slopes sr1, sp1 in the course of the measured value determination, the measuring arrangement 1 is able automatically to compensate measurement errors, which occur as a result of aging related changes of the slopes. For this, the slopes sr1, sp1, of course, need not necessarily be individually calculated in their own computing steps. Rather, the corresponding variables for determining the slopes according to EQs. (9) and (10) can enter directly into the calculating of the pH-value according to EQ. (12). Through the referencing of a first half-cell (pH half-cell), with which a first slope is associated to another half-cell (reference half-cell), with which a second slope is associated, which differs from the first slope, it is possible to omit a conventional reference electrode with liquid junction.

The individual half-cells 2.1, 2.2, 3.1, 3.2 of the apparatus can have a visible marking, which enables a user to identify the half-cells. For example, the inner electrolytes can be colored with different colorants. Especially, inner electrolytes with the same pH-value can contain the same colorant. It is also possible to arrange in the chamber containing the internal electrolyte an identification body, e.g. a colored solid body, of a material chemically inert relative to the internal electrolyte.

Measured with the measuring arrangement illustrated in FIG. 1 can be besides the pH-value of the measured liquid 15 also its redox potential. Based on the ascertained pH measured value, it is possible from one of the equations (5)-(8) to ascertain the half-cell potential of one of the half-cells and from the measured potential difference between the potential sensing element and the reference electrode to calculate the reference potential x. The redox potential of the measured liquid 15 can be derived from the reference potential.

Since the reference potential x of the reference electrode 14 is accessible through the measuring arrangement 1, it is also possible, with the assistance of the reference electrode 14 to perform other potentiometric measurements of other parameters.

FIG. 3 shows a measuring arrangement 100, which is a variation of the measuring arrangement 1 illustrated in FIG. 1. All parts of the measuring arrangement 100 identical with the measuring arrangement 1 are labeled with identical reference characters. By means of the measuring arrangement 100, it is possible in equal manner as described based on FIG. 1 to ascertain a pH-value of the measured liquid 15 as well as the reference potential x of the reference electrode 14.

Additionally, the measuring arrangement 100 has an ion-selective electrode 16, which has a housing, which is sealed on its base end by an ion-selective membrane 17, and in which an inner electrolyte 19 is accommodated. There forms on the ion-selective membrane 17 in contact with the measured solution, dependent on the activity of a certain ion, e.g. chloride or ammonium, in the liquid, a potential, which can be registered relative to the reference electrode 14 by means of the potential sensing element 18 embodied, for example, as a metal wire, which is connected with the measuring circuit 12. With knowledge of the reference potential x, a measured value of the ion activity can be ascertained by the evaluation circuit 13 based on the voltage registered between the potential sensing element 18 and the reference electrode 14.

In a variation of the example of an embodiment described here, an option is to provide only three half-cells having pH-sensitive membranes. In this case, two of the three half-cells can have equally embodied pH-sensitive membranes, however, inner electrolytes with pH-values, which are different from one another, so that the half-cell potentials of the two half-cells are describable as a function of the pH-value of a measured liquid contacting the membranes as linear functions at least in a portion of the characteristic curves with a slope the same for the two membranes but with different zero points. The third half-cell has a pH-sensitive membrane with another composition and an inner electrolyte, whose pH-value equals the pH-value of one of the inner electrolytes of the other two half-cells. A linear function describing the dependence of the half-cell potential of the third half-cell at least in a portion of the pH-scale has, thus, a slope different from the slope associable with the first two half-cells. The zero-point of this function equals one of the zero-points of the other two half-cells, is, however, different from the zero-point of the remaining half-cell. With this measuring arrangement, in manner analogous to the example of an embodiment based on FIG. 1, a sufficiently determined equation system can be set up, which permits ascertaining a current value of the slope of the first two half-cells together with the measured value determination. The slope associated with the third half-cell can, in such case, not currently be determined. If, however, one selects as glass membrane of the third half-cell a conventional glass membrane, which leads to a slope in the region of the theoretical value of 59 mV/pH, then a regular determining of the slope is not necessarily required. Rather, in this embodiment, in given cases, by means of a calibration performed from time to time, a sufficiently exact measured value determination can be assured over longer time periods.

The time curves of the slope-values sr1, sp1 determined, for example, with the equations (9) and (10), simultaneously with the measured value ascertainment, can be evaluated by the evaluation circuit 13 for diagnostic purposes. For example, one or more threshold values can be stored in a memory of the evaluation circuit 13 for specifying a warning, or alarm, threshold. If one of the slope-values falls below the predetermined threshold value, the measuring and evaluation unit 21 can output a warning report, which indicates to a user that the measuring arrangement must be calibrated or replaced. Through extrapolation of a time curve of the slope-values also a time span can be predicted for when a slope falls below the predetermined threshold value. From this prediction a point in time in the future can be derived, for when a calibrating or a replacement of the measuring apparatus or at least one of the half-cells is required, and such point in time can then be output from the measuring and evaluation unit 21.

Based on Equation (12), an estimate of the achieved accuracy of measurement can be performed. This can be output from the measuring and evaluation system supplementally to the current measured value.

FIG. 4 shows the results of a three-point calibration of two examples of a measuring arrangement according to FIG. 2. Measuring arrangement 1 (squares) and measuring arrangement 2 (circles) were, in each case, placed first in a first buffer solution with pH-value 4, then in a second buffer solution with pH-value 7 and lastly in a third buffer solution with pH-value 9.2 and the pH measured value obtained using the measuring method explained based on FIG. 2 registered after achieving a predetermined stability criterium. Plotted on the abscissa of the graph illustrated in FIG. 4 is the pH-value of the buffer solutions and on the ordinate the pH measured value ascertained based on the measurement signals of the measuring arrangement 1 and the measuring arrangement 2. Both measuring arrangements show in the considered pH value range an approximately linear behavior. It is, consequently, in practice possible to ascertain pH measured values with sufficient accuracy based on a linear characteristic curve using the measuring and evaluation system based on the measurement signals of the measuring arrangement according to FIG. 2.

FIG. 5 shows results of an experimental investigation of the drift behavior of a measuring arrangement according to FIG. 2. In the graph illustrated in FIG. 5, pH measured values are plotted as a function of time, in each case, as registered by means of a sensor of the invention (diamonds) comprising a measuring arrangement according to FIG. 2 and a conventional, comparison sensor (crosses) embodied as a single-rod measuring chain. Serving here as comparison sensor was a potentiometric single-rod measuring chain with a measuring half-cell comprising a pH-sensitive glass membrane and a reference half-cell comprising a silver/silver chloride electrode and a liquid internal electrolyte in electrolytic contact with the measured medium via a ceramic diaphragm. The liquid inner electrolyte flowing out via the diaphragm into the measured liquid was replenished from time to time. Such a pH-sensor has the initially stated disadvantages of conventional potentiometric pH-sensors only to a lesser degree and was used, consequently, as a representative for comparative measurements. In practical use, especially in process measurements technology, the flowing out of the liquid reference electrolyte and the requirement of replenishing the reference electrolyte is, however, in many cases, not an ideal situation.

The measuring arrangement and the comparison sensor were over a time period of 3 months alternately supplied with a first buffer solution with pH-value 4 and with a second buffer solution with pH-value 7. The obtained pH measured values of the comparison sensor show in the graph of FIG. 5, as expected, only a slow drift to lower pH-values. The pH measured values of the measuring arrangement of the invention show in comparison thereto a somewhat stronger drift, yet are, however, surprisingly stable, especially taking into consideration the fears expressed in H. Galster states in his textbook “pH-Messung, Grundlagen, Methoden, Anwendungen, Geräte (pH-Measurement, Principles, Methods, Applications, Devices”, Chapter 3.3.3, Publisher: VCH Verlagsgesellschaft, Weinheim, Germany 1990, as regards a poor stability of the reference potential.

The above described invention is not limited to potentiometric arrangements for pH-measuring by means of pH-sensitive membranes. In quite analogous manner, the here explained principles of the measuring arrangement and the here explained method can be applied to other sensors, especially to arrangements for pH-measuring with pH-sensitive electrodes, for example, electrodes comprising a pH-sensitive glass membrane, with directly contacting potential sensor, pH-sensitive enamel electrodes, electrodes comprising pH-sensitive hydrogels or pH-sensitive metal/metal oxide electrodes, e.g. bismuth-, antimony-, to palladium- or iridium electrodes. Moreover, the here explained principles of the measuring arrangement and the here explained method can be applied to other ion-selective electrodes (ISE). Equally, the invention can be applied to a measuring arrangement, especially for pH-measurement with EIS structures (EIS stands for electrolyte insulator structure), especially with half-cells comprised of ISFETs (ion-selective field effect transistors). Basically, the invention can be applied also to pH-measurements by means of redox mediators.

1-26. (canceled)

27. A measuring arrangement, comprising:
at least three half-cells, each of which has a pH-sensitive membrane; and
a measuring circuit, which is embodied to register a half-cell potential of each half-cell relative to a shared reference potential, wherein:
the half-cell potential of each half-cell depends on the pH-value of a measured liquid contacting its pH-sensitive membrane, in such a manner that each half-cell has a respective sensitivity;
the sensitivity of a first of the three half-cells corresponds to a change of its half-cell potential relative to a change of the pH-value of the measured liquid causing it;
the sensitivity of a second of the three half-cells corresponds to a change of its half-cell potential relative to a change of the pH-value of the measured liquid causing it;
the sensitivity of a third of the three half-cells corresponds to a change of its half-cell potential relative to a change of the pH-value of the measured liquid causing it;
the sensitivity of the first half-cell differs from the sensitivity of the second half-cell; and
the half-cell potential of the first half-cell has a first zero-point as a function of the pH-value of the measured liquid, the half-cell potential of the second half-cell has a second zero-point as a function of the pH-value of the measured liquid, and the half-cell potential of the third half-cell has a third zero-point as a function of the pH-value of the measured liquid, and wherein the first zero-point differs from the third zero-point.

28. The measuring arrangement as claimed in claim 27, wherein:
the sensitivity of the first half-cell equals the sensitivity of the third half-cell.

29. The measuring arrangement as claimed in claim 27, wherein:
the first zero-point differs from the second zero-point.

30. The measuring arrangement as claimed in claim 27, wherein:
the measuring arrangement further includes at least a fourth half-cell having a pH-sensitive membrane, whose half-cell potential depends on the pH-value of the measured liquid contacting the sensitive membrane;
the measuring circuit is embodied to register the half-cell potential of the fourth half-cell relative to the shared reference potential;
the fourth half-cell has a sensitivity, which corresponds to a change of its half-cell potential relative to a change of the pH-value of the measured liquid causing it; and
the sensitivity of the fourth half-cell equals the sensitivity of the second half-cell.

31. The measuring arrangement as claimed in claim 30, wherein:
the half-cell potential of the fourth half-cell has as a function of the pH-value of the measured liquid a fourth zero-point, which differs from the second zero-point.

32. The measuring arrangement as claimed in claim 27, wherein:
all measuring half-cells of the measuring arrangement have different zero-points.

33. The measuring arrangement as claimed in claim 27, wherein:
the half-cells have respective internal electrolytes in contact with their pH-sensitive membranes and, contacting the internal electrolytes, potential sensing elements, which are electrically conductively in contact with the measuring circuit for registering their half-cell potentials; and
the inner electrolyte of the first half-cell has a pH-value different from the pH-value of the internal electrolyte of the third half-cell.

34. The measuring arrangement as claimed in claim 27, wherein:
the half-cells have respective internal electrolytes in contact with their pH-sensitive membranes and, contacting the internal electrolytes, potential sensing elements, which are electrically conductively in contact with the measuring circuit for registering their half-cell potentials; and
the pH-value of the internal electrolyte of each half-cell differs from the pH-value of the internal electrolyte of the respectively other half-cells.

35. The measuring arrangement as claimed in claim 27, wherein:
the first and third zero-points differ by at least 0.5 pH.

36. The measuring arrangement as claimed in claim 27, wherein:
the pH-sensitive membrane of the first half-cell differs in composition from the pH-sensitive membrane of the second half-cell.

37. The measuring arrangement as claimed in claim 27, wherein:
the pH-sensitive membrane of the first half-cell has the same composition as the pH-sensitive membrane of the third half-cell.

38. The measuring arrangement as claimed in claim 27, wherein:
the sensitivity of the first half-cell is reduced relative to the sensitivity of the second half-cell.

39. The measuring arrangement as claimed in claim 27, further comprising:
a reference electrode conductively connected with said measuring circuit and extending into the measured liquid for providing the shared reference potential.

40. The measuring arrangement as claimed in claim 39, wherein:
said reference electrode is an electrode formed of an electrically conductive material, especially it is an inert electrode, whose potential is representative of the redox potential of the measured liquid.

41. The measuring arrangement as claimed in claim 27, further comprising:
a measuring and evaluation system surrounding said measuring circuit, wherein:
said measuring and evaluation system is embodied, based on potential differences between the respective half-cell potentials and the shared reference potential registered by said measuring circuit, to ascertain the pH-value of the measured liquid in contact with the half-cells.

42. The measuring arrangement as claimed in claim 41, wherein:
said measuring and evaluation system is embodied, based on the half-cell potential of the first or second half-cell registered relative to the shared reference potential and based on the half-cell potential of the third or, in given cases, the fourth half-cell registered relative to the shared reference potential, to ascertain a pH measured value.

43. The measuring arrangement as claimed in claim 41, wherein:
said measuring and evaluation system is embodied, based on the potential difference between the half-cell potential of the first half-cell and the reference potential, the potential difference between the half-cell potential of the third half-cell and the reference potential and based on the first and third zero-points, to ascertain a slope representing a sensitivity of the first and the third half-cell.

44. The measuring arrangement as claimed in claim 43, wherein:
said measuring and evaluation system is embodied to evaluate a time development of the slope, in order to ascertain a state at least of the measuring arrangement, especially a state of at least one of the half-cells.

45. The measuring arrangement as claimed in claim 39, wherein:
the shared reference potential is provided by said reference electrode, especially an inert reference electrode, extending into the same measured liquid as the pH-sensitive membranes of the half-cells; and
said measuring and evaluation system is embodied, based on the registered potential differences between the half-cell potentials and the shared reference potential as well as an ascertained pH measured value, to determine the redox potential of the measured liquid.

46. The measuring arrangement as claimed in claim 39, wherein:
the measuring arrangement includes at least one other half-cell, whose half-cell potential depends on a concentration of an analyte present in the measured liquid, especially an analyte different from H+, or H₃O+; and
said measuring and evaluation system is embodied, based on a potential difference between the half-cell potential of the additional half-cell and the potential of said shared reference electrode or the half-cell potential of another half-cell of the measuring arrangement, to determine the concentration of the analyte.

47. The measuring arrangement as claimed in claim 27, wherein:
at least one of the half-cells of the arrangement has a visible marking for identification of the half-cell.

48. A method for determining a pH-value of a measured liquid, especially by means of a measuring arrangement, comprising: at least three half-cells, each of which has a pH-sensitive membrane; and a measuring circuit, which is embodied to register a half-cell potential of each half-cell relative to a shared reference potential, wherein: the half-cell potential of each half-cell depends on the pH-value of a measured liquid contacting its pH-sensitive membrane, in such a manner that each half-cell has a respective sensitivity; the sensitivity of a first of the three half-cells corresponds to a change of its half-cell potential relative to a change of the pH-value of the measured liquid causing it; the sensitivity of a second of the three half-cells corresponds to a change of its half-cell potential relative to a change of the pH-value of the measured liquid causing it; the sensitivity of a third of the three half-cells corresponds to a change of its half-cell potential relative to a change of the pH-value of the measured liquid causing it; the sensitivity of the first half-cell differs from the sensitivity of the second half-cell; and the half-cell potential of the first half-cell has a first zero-point as a function of the pH-value of the measured liquid, the half-cell potential of the second half-cell has a second zero-point as a function of the pH-value of the measured liquid, and the half-cell potential of the third half-cell has a third zero-point as a function of the pH-value of the measured liquid, and wherein the first zero-point differs from the third zero-point;
the method comprising the steps of:
contacting with the measured liquid at least a pH-sensitive membrane of a first half-cell, a pH-sensitive membrane of a second half-cell and a pH-sensitive membrane of a third half-cell;
contacting with the measured liquid of at least one reference electrode providing a shared reference potential;
registering a potential difference respectively between a half-cell potential of the first half-cell and the reference potential, between a half-cell potential of the second half-cell and the reference potential and between a half-cell potential of the third half-cell and the reference potential; and
based on the registered potential differences, determining the pH-value of the measured liquid.

49. The method as claimed in claim 48, wherein:
the half-cell potential of each half-cell is a function of the pH-value of the measured liquid, wherein:
the pH-value of the measured liquid is determined based thereon, characterized in that there is associated with the first half-cell a first slope, which corresponds to a slope of a first linear function, which represents a dependence of the half-cell potential of the first half-cell on the pH-value of the measured liquid, there is associated with the second half-cell a second slope different from the first slope and corresponding to a slope of a second linear function, which represents a dependence of the half-cell potential of the second half-cell on the pH-value of the measured liquid, and there is associated with the third half-cell a third slope different from the second slope, equal to the first slope, and representing a dependence of the half-cell potential of the third half-cell on the pH-value of the measured liquid.

50. The method as claimed in claim 49, wherein:
there is associated with the first half-cell a first zero-point, which corresponds to a zero-point of the first linear function;
there is associated with the second half-cell a second zero-point, which corresponds to a zero-point of the second linear function; and
there is associated with the third half-cell a third zero-point, which corresponds to a zero-point of the third linear function, wherein the first zero-point differs from the third zero-point.

51. The method as claimed in claim 50, wherein:
the slope associated with the first half-cell is determined from the ratio of a difference between the potential difference registered between the first half-cell and the reference potential and the potential difference registered between the third half-cell and the reference potential to a difference between the first and third zero-points.

52. The method as claimed in claim 48, wherein:
supplementally at least one pH-sensitive membrane of a fourth half-cell, especially other pH-sensitive membranes of further half-cells, are supplied with the measured liquid; and
a potential difference between the half-cell potential of the fourth, especially each additional, half-cell, and the shared reference potential enters into determining the pH-value.
